(19) United States
(12) Patent Application Publication
(10) Pub. No.: US 2005/0144827 A1
(43) Pub. Date: Jul. 7, 2005

(54) Card display unit

(76) Inventor: George Raymond Decell JR., Fairfax, VT (US)

Correspondence Address: JAMES MARC LEAS, 37 BUTLER DRIVE, S. BURLINGTON, VT, 05403, US

(21) Appl. No.: 10/751,827

(22) Filed: Jan. 5, 2004

(51) Int. Cl. G09F 3/18

(52) U.S. Cl. 40/654.01

(57) ABSTRACT

A method of advertising and generating advertising business is provided. The method includes the step of providing a display unit for displaying a plurality of display objects, such as business cards. Members of the public may leave their own business cards in the display unit for advertising their own product or service. Next a display manager collects lead information about the member of the public or his or or organization that was voluntarily left by members of the public in the display unit. Next the display manager contacts the potential client based on information left in said display unit by the potential client. The invention also includes a display unit for displaying business cards. The display unit includes a transparent mounting plate, a plurality of business card holders, and a graphic. Horizontally adjacent business card holders, each capable of holding a stack of business cards, are spaced from each other with sufficient spacing so that the graphic can be seen in the spacing.

### FIELD OF THE INVENTION

This invention generally relates to advertising and displays. More particularly, it relates to a unit for displaying stacks of business cards and to a method of generating advertising business by using the unit.

### BACKGROUND OF THE INVENTION

Business card displays on bulletin boards have provided a low cost or free way for businesses to advertise. However, such bulletin board displays quickly become crowded with a large number of cards, flyers, and posters, and the resulting disorderly display has reduced value for advertising. Wall and desk mounted display units have been used for displaying and dispensing post cards, greeting cards and business cards. However, these units have not received wide acceptance for developing a business card display business.

Thus, a better display and a better method of building a business with a business card display unit is needed that allows members of the public to view and take cards that advertise desired services while maintaining a neat, attractive, and orderly appearance for the display as a whole, and that provides an automatic way for the business to expand. The improved display unit system and method of doing business is provided by the following invention.

### SUMMARY OF THE INVENTION

It is therefore an object of the present invention to provide a display unit that has a plurality of card holders for holding stacks of different business cards, each of which is accessible for taking by viewers, while people viewing the display also have access to the card holders for adding their own stacks of cards to empty card holders in the display;

It is a further object of the present invention for a sales agent to collect information from one of the cards left by a member of the public in the public display unit and to contact that person or organization for arranging for further participating in the advertising display;

It is a feature of the present invention that the display is used both for dispensing business cards to the public and for collecting business cards from viewers for expanding contacts for building the advertising business; and

It is an advantage of the present invention that the display can be used both to display cards and to collect contact information of prospective users of the advertising service.

These and other objects, features, and advantages of the invention are accomplished by a display unit, comprising a transparent mounting plate, a plurality of business card holders, and a graphic. Horizontally adjacent business card holders are spaced from each other with sufficient spacing so that the graphic can be seen in the spacing. Each said business card holder is capable of holding a stack of business cards.

Another aspect of the invention is a method of advertising, comprising the step of providing a display unit having a plurality of card holders in a publically accessible location. Next, stacks of business cards are placed in the card holders wherein each stack is accessible to members of the public and wherein members of the public are invited to add their own business cards to any empty card holders.

Another aspect of the invention is a method of advertising, comprising the step of providing a display unit having a plurality of card holders in a public place. A potential client can deposit a stack of business cards in one of the card holders. The next step is for a sales agent to collect the business cards left by such potential clients in the card holders. Next the agent contacts potential clients based on information in the business cards left by the potential client.

Another aspect of the invention is a method of advertising, comprising the step of providing a display unit for displaying a plurality of display objects wherein the display unit includes a message inviting potential clients to leave a stack of their advertising material in the display unit. The next step is collecting lead information voluntarily left by these potential clients in the display unit. The next step is contacting the potential clients based on information left by the potential clients.

### BRIEF DESCRIPTION OF THE DRAWINGS

The foregoing and other objects, features, and advantages of the invention will be apparent from the following detailed description of the invention, as illustrated in the accompanying drawings, in which:

FIG. 1a is a front view of display unit of the present invention including a mounting board, card holders, and an advertisement encouraging viewers to leave their own business cards in the display unit;

FIG. 1b is a a front view of an alternate embodiment of the display unit of the present invention in which the card holders allow a nearly full view of the cards in the card holders;

FIG. 2 is a front view of display unit of the present invention including a graphic mounted behind the transparent mounting board; and

FIG. 3 is a flow chart of the method of doing business of the present invention.

### DETAILED DESCRIPTION OF THE INVENTION

The present inventor recognized the importance to providers of products and services of an organized and attractive display of business cards in public places. He further recognized several problems with traditional bulletin board displays, traditional business card display units, and the methods of doing business with such card display units. Further, he recognized ways to improve display units to provide a low cost and attractive way for many such providers to achieve wide recognition for their products and services and for a display unit provider to make a successful business of providing the display service. Further, he recognized that the self-advertising business process model provided by the bulletin board displays could be extended to provide a new business model for advertising, as exemplified by the method using the card display unit.

To solve the problems inherent in traditional bulletin board displays the present inventor designed a display unit that allows for display of multiple stacks of business cards while providing additional empty card holders allowing members of the public to add their own business cards to the display. An invitation to do so may be included int eh display. The display manager then collects cards left by members of the public and uses information on the cards to contact these self-advertising members of the public. Members of the public who leave their cards in the display become prime contacts for participating in the display advertising.

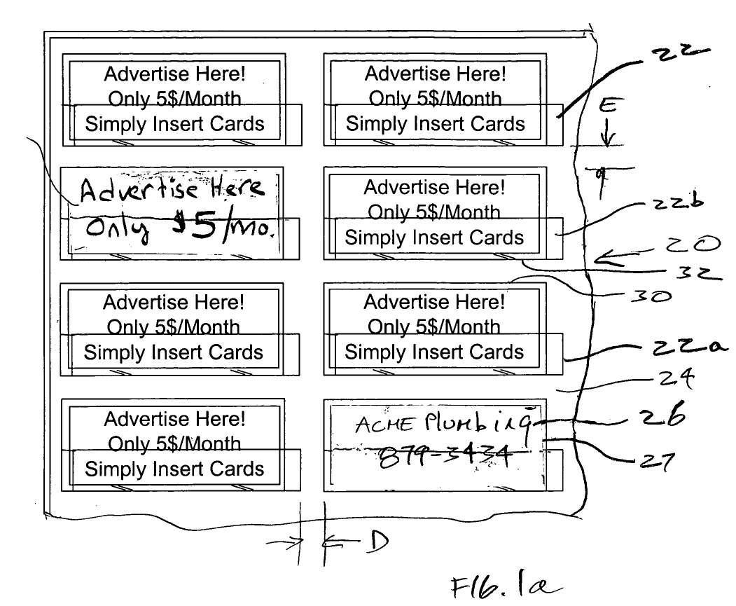

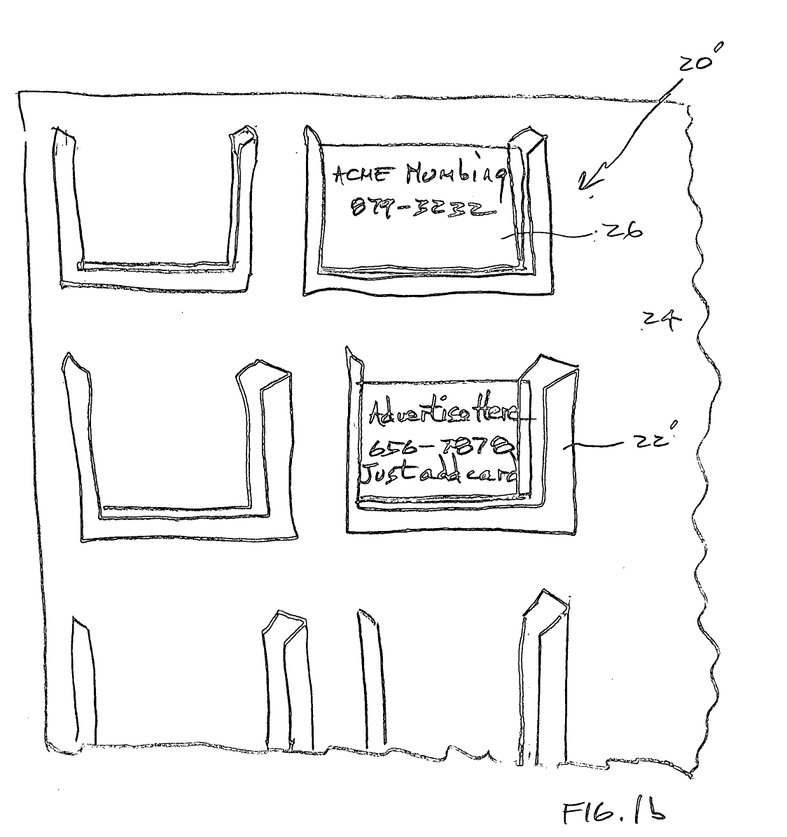

Display unit 20 includes card holders 22 mounted on mounting board 24, as shown in FIG. 1a. Mounting board 24 is preferably fabricated of a transparent material, such as acrylic, plexiglass, or a polycarbonate. However, an opaque or translucent mounting board can also be used. Card holders 22 are for holding and displaying stacks of business cards 26 in an upright position so that members of the public who may be passing by can readily see the cards of the display and the advertising material they contain. Preferably each card holder 22 has room to hold a stack of at least about 30 business cards 26 in an upright or nearly vertical position.

Card holders 22 are also preferably fabricated of the same transparent material as mounting board 24. Opaque or translucent card holders can be used where business cards 26 extend sufficiently above top edge 27 of card holders 22 for printing on the cards to still be seen. Transparent, translucent, or opaque card holders can also be used where card holders are configured as shown in U.S. Pat. No. 5,092,062 to Palka or U.S. Pat. No. Des. 367,987 to Farrell, or as shown in FIG. 1b, so that virtually the entire front face of business cards 26 can be seen without obstruction from card holder 22′ itself. Display unit 20, 20′ can also be used to display other kinds of cards, such as greeting cards, photographs, brochures, picture post cards, and the like, and for these types of cards the dimensions of the card holders are correspondingly adjusted.

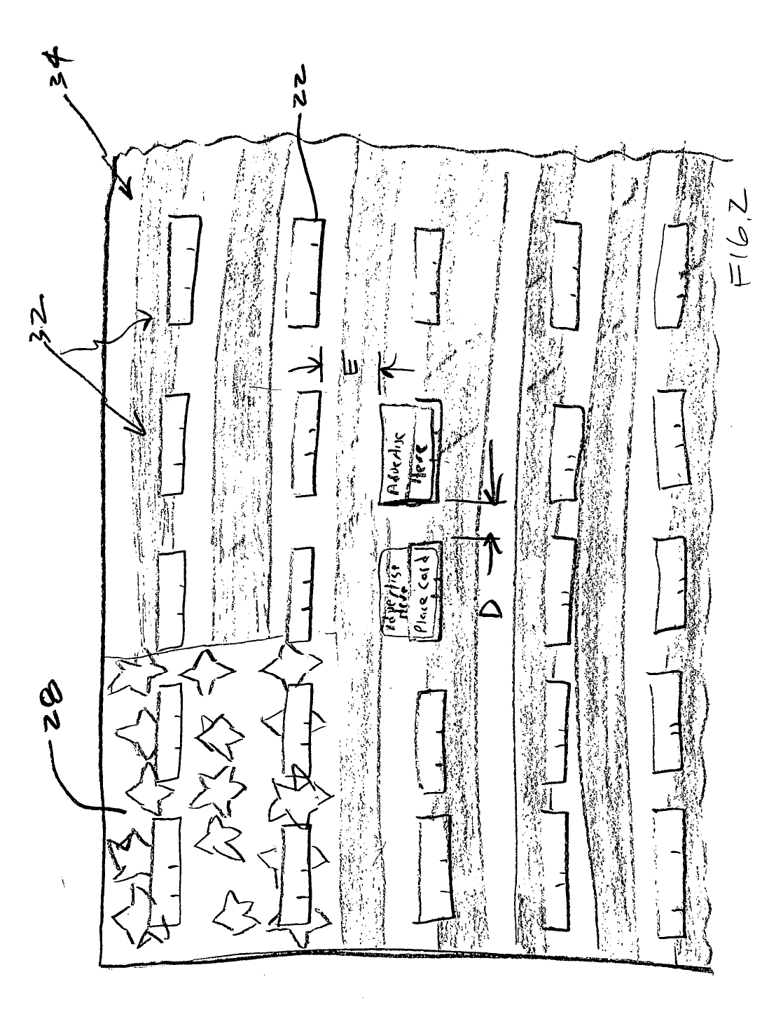

Card holders 22, 22′ may be spaced apart with spacings D and E to provide visibility for display poster 28 (FIG. 2) located behind mounting board 24. Spacing D represents the horizontal space between adjacent card holders 22, 22′. Spacing E represents the vertical space between top edge 30 of business card 26 in card holder 22a and bottom surface 32 of next higher card holder 22b, and therefore the exact amount of this spacing E may vary depending on the dimensions of business cards 26.

Display poster 28 located behind transparent mounting board 24 may include any graphic 34, such as an American flag graphic, as shown in FIG. 2. Spacing D is preferably in the range of about ½ inch to about 2 inches to provide sufficient visibility to graphic 34. More preferably, spacing D is in the range of about ½ inch to about ¾ inches. For standard business cards, spacing E is preferably in the range from about 0.75 inch to about 1½ inches. More preferably spacing E is about equal to 1 inch.

Graphic 34 can also include an advertisement in locations of card holders 22, 22′, such as “Advertise Here, insert your cards here,” as shown in the locations of two of the card holders in FIG. 2. This advertisement could also be provided on a sticker placed either on the front or back surface of mounting board 24 in the locations of card holders 22, 22′, as shown in FIGS. 1a, 1b. Thus, when a person adds his or her business cards to the display this advertising is covered up. Alternatively, business cards with this advertisement could be used for this same purpose.

Mounting board 24 may have a rear mounting mechanism (not shown), such as a hanger or wire, to permit it to be mounted on a wall. Mounting board 24 can also have holes that can be used with a screw for mounting it to a wall. Alternatively, mounting board 24 may have support brackets (not shown) for holding it up on a table or directly on the floor. At least for table or floor mounting, mounting board 24 should by sufficiently stiff to support itself and card holders 22 in an upright position. A wall mounted unit could be fabricated of thinner material or a backing material can be provided to add support. A complex display or a display that rotates may be fabricated using mounting board 24 or several such mounting boards as described in U.S. Pat. No. D 373,919 to Farrell.

Card holders 22, 22′ may be fabricated of a single piece of curved plastic or they may include separate front, side, and bottom plates. Card holders 22 may be adhesively connected to mounting board 24. Adhesives such as epoxy and such glues as super glue can be used. Alternatively, card holders 22 may be formed as a unitary structure with mounting board 24 by using an approapriate plastic fabricating process, such as injection molding.

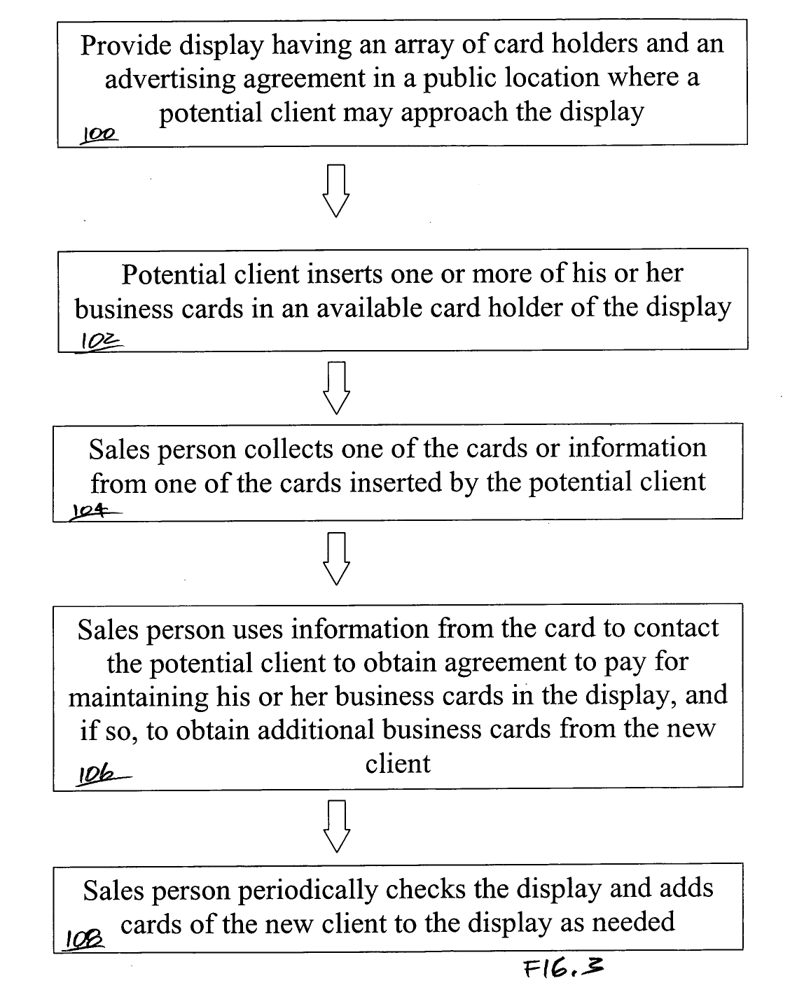

The present invention involves a business process in which display 20 having array 32 of card holders 22, 22′ is provided in a public location where a potential client of one of the card advertisers may approach display 20, as shown in step 100 of FIG. 3. Public locations include all locations where members of the public can go, such as stores, offices, malls, hotels, restaurants, and other public places. Display 20 may also include an advertisement inviting members of the public to advertise here by simply inserting the person's own business cards in an available card holder 22, 22′, as shown in step 102. The advertisement can be on poster 28 located behind transparent mounting board 24, on a sticker placed on either the front or rear surface of mounting board 24, or it can be on a business card located in otherwise unused card holders 22, 22′. Next a display manager collects one of the cards left by the member of the public, as shown in step 104. Alternatively, the display manager may just copy information from one of the cards concerning the potential client. In the next step, the display manager uses information from the card to contact the potential client to obtain agreement to pay for maintaining his or her business cards in the display unit, as shown in step 106. Payment may be on a regular monthly schedule. If agreement is reached, the display manager may ask for additional business cards from the new client or otherwise obtains additional cards to be used for refilling the display when it is depleted. Finally, the display manager periodically checks the display and adds additional cards of the new client to the display as needed, as shown in step 108.

While several embodiments of the invention, together with modifications thereof, have been described in detail herein and illustrated in the accompanying drawings, it will be evident that various further modifications are possible without departing from the scope of the invention. For example, other types of cards or display vehicles can be used besides business cards, such as brochures. In either case the potential client initiates contact by adding his or her own card or brochure to an empty card or brochure holder. Nothing in the above specification is intended to limit the invention more narrowly than the appended claims. The examples given are intended only to be illustrative rather than exclusive.

1. A display unit, comprising a transparent mounting plate, a plurality of business card holders, and a graphic, wherein horizontally adjacent business card holders are spaced from each other with sufficient spacing so that said graphic can be seen in said spacing, and wherein each said business card holder is capable of holding a stack of business cards.

2. A display unit as recited in claim 1, wherein horizontally adjacent business card holders are spaced from ½ inch to 2 inches apart.

3. A display unit as recited in claim 1, wherein vertically adjacent business card holders are spaced so the top of a business card in a card holder is from ¾ inch to 1½ inches from the bottom of the next higher business card holder.

4. A display unit as recited in claim 1, wherein each said business card holder is bonded to said mounting plate.

5. A display unit as recited in claim 1, wherein each said business card holder is adhesively attached to said mounting plate.

6. A display unit as recited in claim 1, wherein said mounting plate and said business card holders are a unitary structure.

7. A display unit as recited in claim 1, further comprising a structure for mounting said mounting plate on a wall.

8. A display unit as recited in claim 1, further comprising a stand for holding said mounting plate.

9. A method of advertising, comprising the steps of
a) providing a display unit having a plurality of card holders in a publically accessible location;
b) placing stacks of business cards in said card holders wherein each said stack is accessible to members of the public and wherein members of the public can add their own business cards to an empty card holder;
c) collecting a business card or information from a business card left in said card holder by said potential client; and
d) contacting said potential client based on said information in said business card.

10. A method as recited in claim 8, wherein said step (b) further comprises the step of inviting members of the public to add their own business cards to an empty card holder.

11. A method as recited in claim 8, wherein said step (b) further comprises the step of notifying members of the public that they will be contacted if they add their own business cards to an empty card holder.

12. A method as recited in claim 8, further comprising the step of refilling a card holder with cards of a client paying to advertise in said display unit.

13. A method as recited in claim 8, wherein said display unit comprises a mounting plate and card holders.

14. A method as recited in claim 12, wherein said display unit comprises a structure for supporting said mounting plate.

15. A method of advertising, comprising the steps of
a) providing a display unit having a plurality of card holders in a public place, wherein a potential client can deposit a stack of business cards in one of said card holders;
b) collecting a business card or information from a business card left in said card holder by said potential client; and
c) contacting said potential client based on said information in said business card.

16. A method of advertising and generating advertising business, comprising the steps of:
a) providing a display unit for displaying a plurality of display objects;
b) collecting lead information voluntarily left by potential client in said display unit, wherein said information is provided in said display unit for advertising by said potential client;
c) contacting said potential client based on information left in said display unit by said potential client.
